(19) United States
(12) Patent Application Publication
(10) Pub. No.: US 2011/0250772 A1
(43) Pub. Date: Oct. 13, 2011

(54) SMALL SIZED STACKED CARD CONNECTOR WITH EJECTOR FACILITATING EJECTION OF A SIM CARD

(75) Inventor: WEI-DE ZHANG, Shenzhen (CN)

(73) Assignee: HON HAI PRECISION INDUSTRY CO., LTD., New Taipei (TW)

(21) Appl. No.: 13/080,697

(22) Filed: Apr. 6, 2011

(30) Foreign Application Priority Data
Apr. 7, 2010 (CN) 201020151466.9

(51) Int. Cl. H01R 13/62

(52) U.S. Cl. 439/159

(57) ABSTRACT

A card connector (100) for receiving two cards includes an insulative housing (1), an intermediate cover (5) covering a lower part of the insulative housing for defining a lower receiving space (9), an upper cover (4) covering the insulative housing, a plurality of first contacts (2) and a plurality of second contacts (3) retained in the insulative housing, and an ejector (6) assembled in the insulative housing. The upper cover together with the intermediate cover and the insulative housing define an upper receiving space (8). The first contacts and the second contacts respectively extend into the upper receiving space and the lower card receiving space for contacting the two cards. The first contacts have contacting portions (21) arranged at two rows along a front-and-back direction. The ejector includes a slider (60) having a pushing bar (64) extending between the two rows of first contacts and movable along the front-and-back direction.

### CROSS-REFERENCE TO RELATED APPLICATIONS

This patent application relates to a U.S. patent application Ser. No. 12/888,466, filed on Sep. 23, 2010, entitled “STACKED CARD CONNECTOR”, which is assigned to the same assignee as this application.

### BACKGROUND OF THE INVENTION

1. Field of the Invention

The present invention relates generally to a card connector, and more particularly to a small sized stacked card connector defining two spaces for both a micro SD (Secure Digital) card and a SIM (Subscriber Identity Module) card, which has an ejector facilitating ejection of the SIM card.

2. Description of Related Arts

A stacked card connector including a first card connector such as a SIM card connector and a second card connector such as an SD card connector is widely used nowadays. The SD card connector usually comprises a push-push ejector for guiding/ejecting an SD card. However, a user inserts a SIM card in the SIM card connector and withdraws the SIM card out of the SIM card connector by fingers. Because the SIM card connector is small in size and thin, it is inconvenient in withdrawing the SIM card without the aid of an ejector.

U.S. Pat. No. 7,811,106 issued on Oct. 12, 2010, and having the same assignee as the present patent application discloses a SIM card connector which has an ejector for ejecting an inserted SIM card. The SIM card connector has an ejector assembled on a side of its insulative housing. The ejector comprises an operating lever extending along a card insertion direction and an ejecting lever extending along a transverse direction. The ejecting lever pivotally rotates, when the operating lever is operated, and then ejects an inserted card out.

The ejector is assembled an uppermost surface of the insulative housing, which increases a height of the SIM card connector. Furthermore, the operating lever of the ejector is positioned beside the housing so the width of the card connector is increased. Overall, the card connector with such an ejector has a large size. Moreover, the movement of the ejecting lever curvedly pushing the card may not eject the SIM card with a balanced force.

Hence, a stacked card connector both reducing in height and width and balancedly ejecting the inserted card is desired to overcome the aforementioned disadvantage of the prior art.

### SUMMARY OF THE INVENTION

Accordingly, an object of the present invention is to provide a stacked card connector both reducing in height and width and balancedly ejecting the inserted card.

To achieve the above object, a card connector for receiving two cards includes an insulative housing, an intermediate cover covering a lower part of the insulative housing for defining a lower receiving space, an upper cover covering the insulative housing, a plurality of first contacts and a plurality of second contacts retained in the insulative housing, and an ejector assembled in the insulative housing. The upper cover together with the intermediate cover and the insulative housing define an upper receiving space. The first contacts and the second contacts respectively extend into the upper receiving space and the lower card receiving space for contacting the two cards. The first contacts have contacting portions arranged at two rows along a front-and-back direction. The ejector includes a slider having a pushing bar extending between the two rows of first contacts and movable along the front-and-back direction.

Other objects, advantages and novel features of the invention will become more apparent from the following detailed description when taken in conjunction with the accompanying drawings.

### BRIEF DESCRIPTION OF THE DRAWINGS

FIG. 1 is a first perspective, partly exploded view of a stacked card connector constructed in accordance with the present invention when an upper cover is separated from an insulative housing;

FIG. 2 is a second perspective, partly exploded view of the stacked card connector when a metal plate is also separated from an ejector for a SIM card with respect to FIG. 1;

FIG. 3 is a third perspective, partly exploded view of the stacked card connector when an intermediate cover is also separated from the insulative housing with respect to FIG. 2;

FIG. 4 is a fourth perspective, partly exploded view of the stacked card connector with the upper cover, the metal plate, and the ejector for the SIM card separated from the insulative housing but the intermediate cover is attached to the insulative housing; and

FIG. 5 is a perspective, assembled view of the stacked card connector.

### DETAILED DESCRIPTION OF THE PREFERRED EMBODIMENT

Reference will now be made in detail to the preferred embodiment of the present invention.

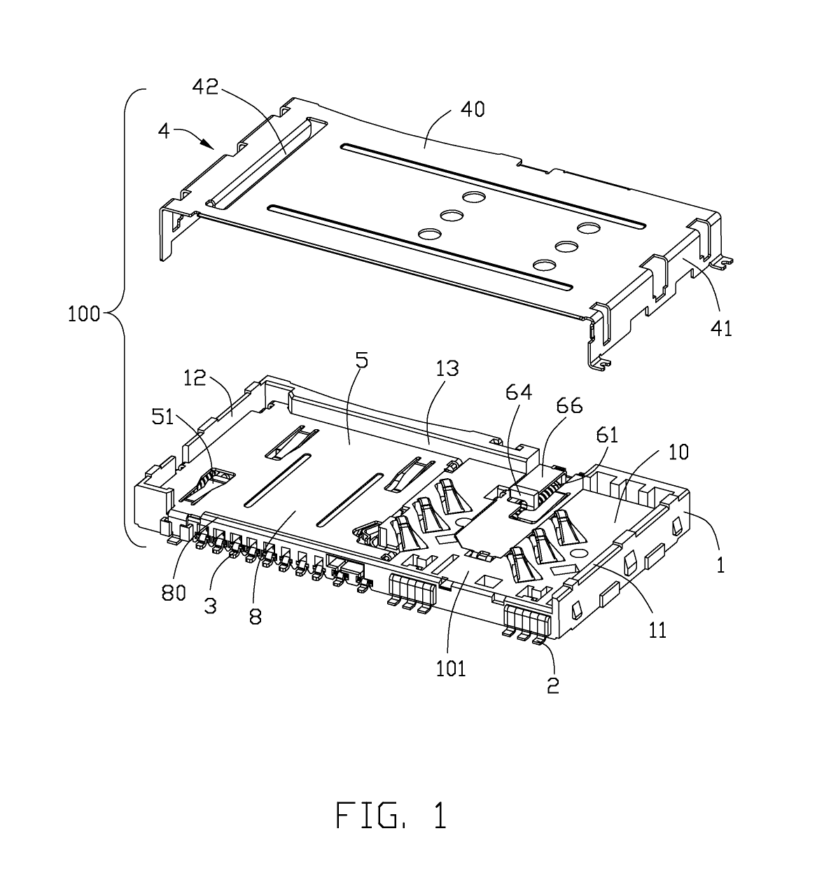

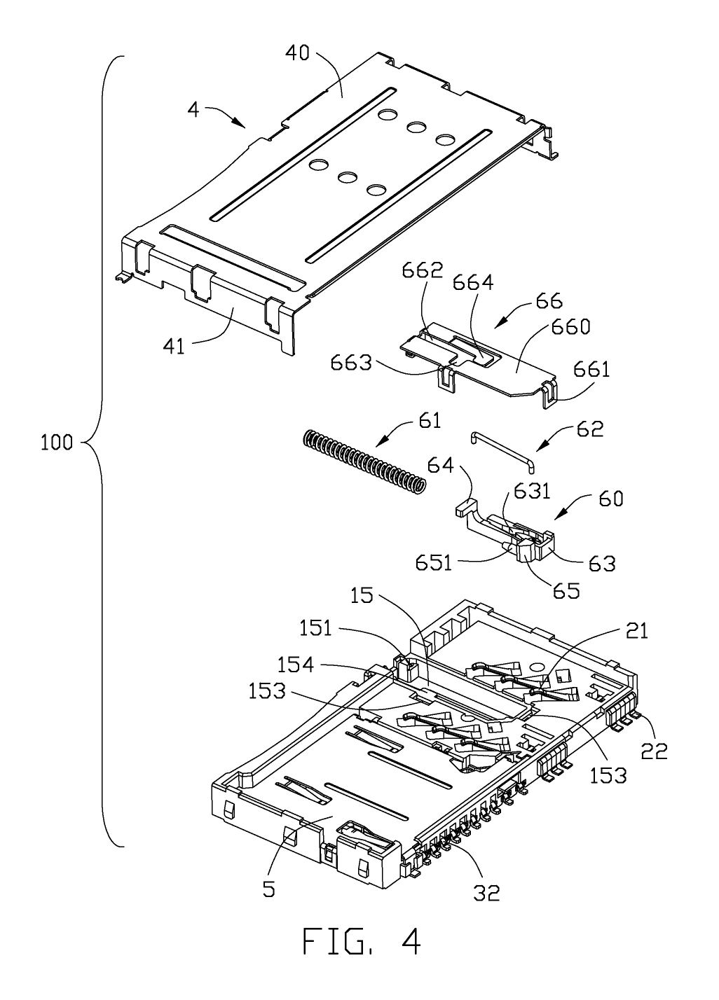

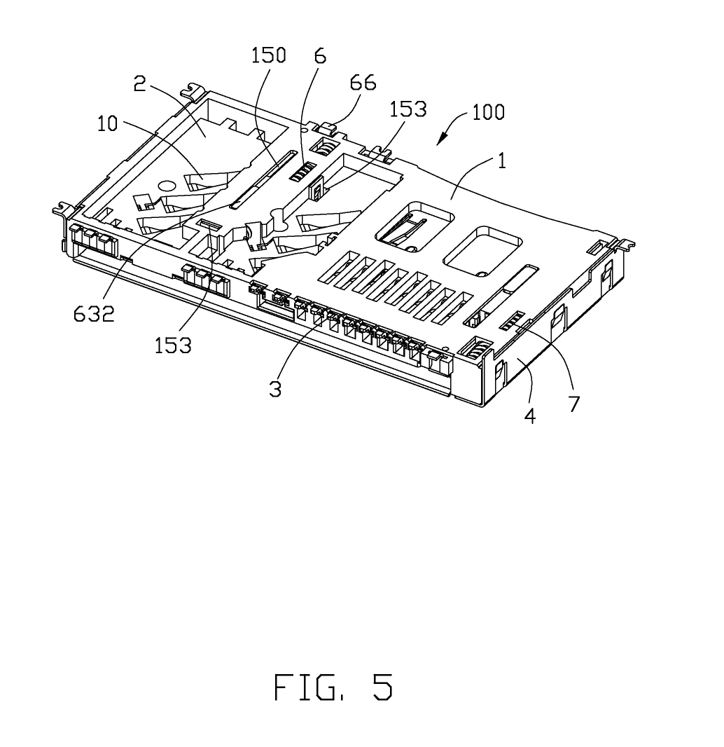

Referring to FIGS. 1-5, a stacked card connector 100 in accordance with the present invention used for receiving both a SIM (Subscriber Identity Module) card (not shown) and a micro SD (Secure Digital) card (not shown), comprises an elongated insulative housing 1, a plurality of first contacts 2 and a plurality of second contacts 3 received in the insulative housing 1 for respectively connecting with the SIM card and the micro SD card, a first cover 4 and a second cover 5 both assembled on the upper side of the insulative housing 1, and a first ejector 6 and a second ejector 7 both assembled on the insulative housing 1 for respectively ejecting the SIM card and the micro SD card.

Referring to FIGS. 1-5, the insulative housing 1 comprises a base portion 10, a right wall 11 and a left wall 12 extending upwardly from two lateral edges of the base portion 10, and a rear wall 13 extending upwardly from a rear edge of the base portion 10. The base portion 10 of the insulative housing 1 further comprises a pair of left-and-right positioned, lower-and-upper parts, with the upper part abutting to the right wall 11 and the lower part abutting to the left wall 12. The second cover 5 is assembled on the upper side of the lower part of the insulative housing 1 for defining a second receiving space 9 with a second insertion opening 90 for loading the micro SD card therein. The second cover 5 lies substantially coplanar with the upper part of the insulative housing 1. The first cover 4, the second cover 5, the upper part of the insulative housing 1, the right wall 11 cooperatively define a first receiving space 8 with a first insertion opening 80 for loading the SIM card therein. The SIM card and the micro SD card are inserted into their corresponding receiving spaces 8, 9 along opposite card insertion directions. The first contacts 2 are retained in the upper part of the insulative housing 1 and extend into the first receiving space 8 for connecting with the SIM card. The second contacts 3 are received in the lower part of the insulative housing 1 and extend into the second receiving space 9 for connecting with the micro SD card.

Referring to FIGS. 1-4, the first contacts 2 comprise a plurality of first contacting portions 21 angularly extending into the first receiving space 8 along a SIM card insertion direction and a plurality of first soldering portions 22 extending outside of the insulative housing 1. The second contacts 3 comprise a plurality of second contacting portions 31 extending into the second receiving space 9 along a micro SD card insertion direction opposite to the SIM card direction and a plurality of second soldering portions 32 extending outside of the insulative housing 1. The first soldering portions 21 of the first contacts 2 and the second soldering portions 31 of the second contacts 3 are arranged in a line adjacent to the first insertion opening 80 for facilitating soldering on a printed circuit board (not shown).

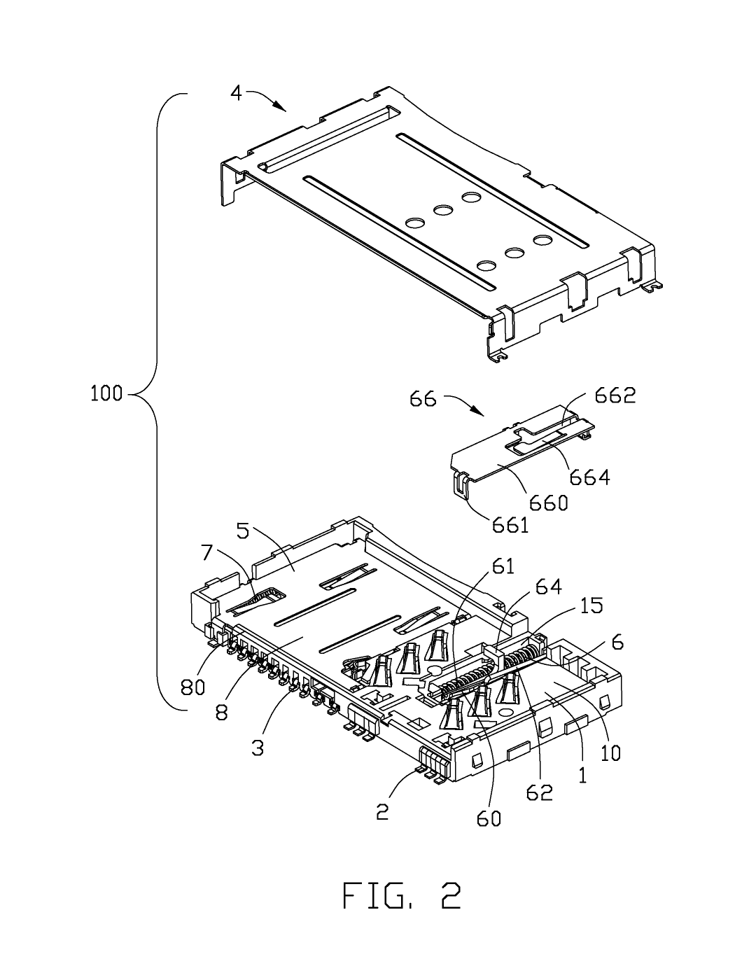

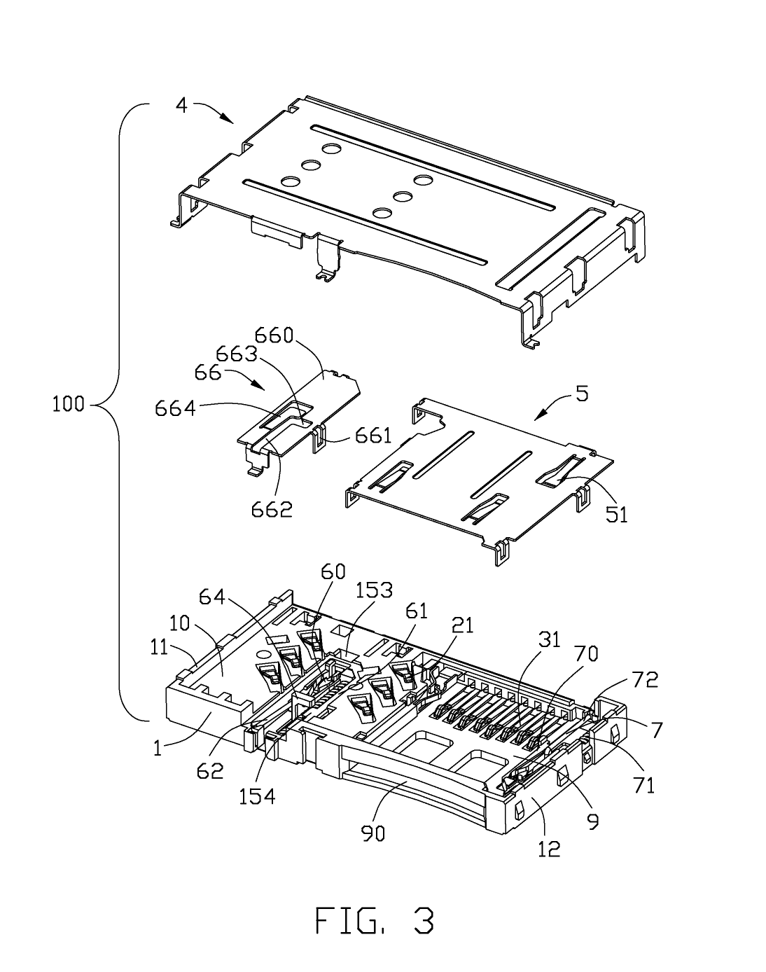

Referring to FIGS. 2-3, the first cover 4 and the second cover 5 are both assembled on the upper side of the insulative housing 1. The first cover 4 is located higher than the second cover 5. The first cover 4 is almost twice the length of the second cover 5 and the width of the first cover 4 is nearly the same as that of the second cover 5. Accordingly, the first receiving space 8 is almost twice the size of the second receiving space 9, and the first insertion opening 80 is twice the size of the second opening 90. The first cover 4 comprises a main portion 40 and a pair of vertical walls 41 extending downwardly from two opposite edges of the main portion 40 for securing to the left, right walls 12, 11 of the insulative housing 1. The first cover 4 forms a block wall 42 adjacent to one of the vertical walls 41. The block wall 42 essentially narrows the second receiving space 80 for preventing the SIM card from connecting the left wall 12 of the insulative housing 1. The second cover 5 is frame-shaped and comprises a first elastic piece 51 extending towards the second receiving space 9.

Referring to FIGS. 1, 3, 4, and 5, the insulative housing 1 defines a receiving channel 15 on the upper part thereof along the SIM card insertion direction. In the present invention, the receiving channel 15 is positioned between the two rows of the first contacts 2. An aperture 151 is defined at the end of the receiving channel 15. A plurality of retaining slits 153 are dispersed around the receiving channel 15. At least one protrusion 154 protrudes toward the receiving channel 15 from a lateral side of the receiving channel 15. The insulative housing 1 defines an elongated slot 150 communicating with the receiving channel 15 extending throughout a bottom face thereof.

Referring to FIGS. 2-5, the first ejector 6 is assembled in the receiving channel 15 for ejecting the SIM card. The first ejector 6 comprises a slider 60, a spring member 61 biasing the slider 60 along a SIM card ejection direction, and a pin member 62 moveably secured with the slider 60. The slider 60 comprises a base portion 63 defining a heart-shaped groove 631, a pushing bar 64 extending upwardly, laterally from a rear end of the base portion 63, a fixing portion 65 extending laterally from a front end of the base portion 63 along the same direction as the pushing bar 64, and a shaft 651 extending rearward from the fixing portion 63. The slider 60 is received in the receiving channel 15 and further forms a rib 632 protruding in the elongated slot 150. The slider 60 moves along a front-and-rear direction by virtue of the rib 632. The spring member 61 is positioned by the shaft 651 and therefore, is sandwiched between the insulative housing 1 and the slider 60 so as to provide biasing force to the slider 60 along the front-and-back direction. The protrusion 154 presses against the spring member 61 for preventing the spring member 61 from jumping out of its correct position. The pin member 62 has two ends, with one end thereof fixedly secured in the aperture 151 and the other end moveably received in the heart-shaped groove 631. The principle of the push-push ejector 6 is well-known to persons skilled in the art, and it is simply described later.

Referring to FIG. 3, in a preferred embodiment, a metal plate 66 is further assembled to the first ejector 6 for dustproof. The metal plate 66 comprises a sleeve portion 660, a plurality of locking pieces 661 extending downwardly from the sleeve portion 660, a slot 662 defined on the sleeve portion 660, a second elastic piece 664 extending downward toward the pin member 62 for preventing the pin member 62 from jumping out of the heart-shaped groove 631, and a notch 663 facing toward the second elastic piece 664 and is communicated with the slot 662. The pushing bar 64 extends beyond the metal plate 66 through the notch 663 into the first receiving space 8 for ejecting the SIM card. The sleeve portion 660 of the metal plate 66 keeps planar with the upper part of the insulative housing 1, too, for facilitating the SIM card's insertion.

Referring to FIG. 3, the second ejector 7 is assembled on the left wall 12. The second ejector 7 comprises a slider 70, a spring member 71, and a slider pin 72 cooperatively for positioning and ejecting the micro SD card. The second ejector 7 is a push-push ejector, which is well-known to persons skilled in the art, and it will not be described in detail herein. The card connector 100 usually comprises a card lock (not labeled) for securing the micro SD card, which is located in front of the second ejector 7.

When the SIM card is inserted into the first receiving space 8, the SIM card pushes the pushing bar 64 of the slider 60, the slider 60 moves along with the SIM card to an inner position and terminates at the inner position, during which the spring member 61 is compressed for accumulating biasing force. The pin member 62 slidably moves in the heart-shaped groove 631 and is finally positioned at a fixed position of the heart-shaped groove 631.

When the SIM card is ejected from the first receiving space 8 by pushing on the SIM card again along the card insertion direction, the pin member 62 moves away from the fixed position of the heart-shaped groove 631, and the slider 60 moves along the SIM card ejection direction in condition that the biasing force of the spring member 61 is released. The SIM card is pushed out of the first receiving space 8 by the pushing bar 64 of the slider 60.

The first receiving space 8 for receiving the SIM card is stacked on the second receiving space 9 for receiving the micro SD card, and the first ejector 6 is arranged at two rows of the first contacts 2, such that the stacked card connector has a small size. The first ejector 6 actuates along the front-and-back direction for balancedly ejecting the SIM card.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card connector for receiving two cards, comprising:
an insulative housing;
an intermediate cover covering a lower part of the insulative housing for defining a lower receiving space;
an upper cover covering the insulative housing and, together with the intermediate cover and the insulative housing, defining an upper receiving space;
a plurality of first contacts and a plurality of second contacts retained in the insulative housing and respectively extending into the upper receiving space and the lower receiving space for contacting the two cards, the first contacts having contacting portions arranged in two rows along a front-and-back direction; and
an ejector assembled in the insulative housing and comprising a slider having a pushing bar extending between the two rows of first contacts and movable along the front-and-back direction.

2. The card connector as claimed in claim 1, wherein the insulative housing defines a receiving channel on an upper part thereof, and the slider is received in the receiving channel and the pushing bar extends out of the receiving channel and into the upper receiving space.

3. The card connector as claimed in claim 2, wherein the ejector comprises the slider moveable in the receiving channel, a spring member biasing the slider along the front-and-back direction, and a pin member with one end thereof secured with the insulative housing and the other end thereof moveable relative to the slider.

4. The card connector as claimed in claim 2, further comprising a metal plate covering the ejector and lying substantially coplanar with the intermediate cover.

5. The card connector as claimed in claim 4, wherein the metal plate defines a notch and the pushing bar extends beyond the metal plate through the notch into the upper receiving space.

6. The card connector as claimed in claim 5, wherein the metal plate forms an elastic piece extending downward toward and pressing against the pin member.

7. The card connector as claimed in claim 6, wherein the metal plate defines a slot between the notch and the elastic piece and the notch is communicated with the slot.

8. The card connector as claimed in claim 4, wherein the insulative housing defines a plurality of retaining slits dispersed around the receiving channel and the metal plate forms a plurality of locking pieces secured in the retaining slits.

9. The card connector as claimed in claim 1, wherein the upper receiving space and the lower receiving space define opposite insertion openings with one being essentially twice the size of the other one.

10. The card connector as claimed in claim 9, wherein the first terminals and the second terminals have a plurality of soldering portions positioned along a line.

11. A card connector for use with a first card and a second card, comprising:
an insulative housing;
a cover structure assembled to the housing and cooperating with the housing to define an first card receiving cavity for use with the first card and a second card receiving cavity for use with the second card, said first card receiving cavity and said second card receiving cavity being spaced from each other in a vertical direction;
a first set of contacts disposed in the housing with first contacting sections extending into the first card receiving cavity for use with the first card;
a second set of contacts disposed in the housing with second contacting sections extending into the second card receiving cavity for use with the second card;
a first ejection mechanism including a first slider, a first spring and a first pin member associated with one another and essentially commonly located at a level same with the second card receiving cavity under condition that said first slider defines a first pushing bar extending into the first card receiving cavity for use with the first card.

12. The card connector assembly as claimed in claim 11, further including a second ejection mechanism including a second slider, a second spring and a second pin member associated with one another and essentially commonly located in the housing at said level under condition that said second slider defines a second pushing bar extending into the second card receiving cavity for use with the second card.

13. The card connector assembly as claimed in claim 11, wherein the first card receiving cavity is higher than the second card receiving cavity with regard to a mounting surface of the housing which is seated upon a printed circuit board.

14. The card connector assembly as claimed in claim 11, wherein said first set of contacts and said second set of contacts are spaced from each other in a top view.

15. The card connector assembly as claimed in claim 11, wherein said first ejection mechanism is essentially located around an area among the first set of contacts and relative farther away from the second set of contacts.

16. The card connector assembly as claimed in claim 11, wherein the cover includes a first part to separate the first card receiving cavity from the second card receiving cavity, and a second part to cooperate with the first part to define said first card receiving cavity.

17. The card connector assembly as claimed in claim 11, further including a plate to hold the first ejection mechanism in position.

18. The card connector assembly as claimed in claim 11, wherein the first card receiving cavity which complies with the first card, is larger than the second card receiving cavity which complies with the second card.

19. A card connector assembly for use with first and second cards, comprising:
an insulative housing defining first and second areas spaced from each other along a lengthwise direction in a top view;
a first set of contacts disposed in the housing around the first area for use with the first card;
a second set of contacts disposed in the housing around the second area for use with the second card;
a cover cooperating with the housing to define separate first and second card receiving cavities in a vertical direction perpendicular to said lengthwise direction for respective use with the first card and second card;
an ejection mechanism including a slider, a spring and a pin member associated with one another and essentially commonly located in the first area under condition that the slider is essentially located around a center portion of a region defined by the first set of contacts in the top view.

20. The card connector assembly as claimed in claim 19, wherein the slider includes a pushing bar extending in a vertical direction to cross a boundary of said first card receiving cavity and said second card receiving cavity in the vertical direction.
